(19) United States
(12) Patent Application Publication
(10) Pub. No.: US 2007/0183745 A1
(43) Pub. Date: Aug. 9, 2007

(54) Method and system to control recording of a digital program

(75) Inventor: Scott White, Austin, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/351,209

(22) Filed: Feb. 8, 2006

(51) Int. Cl. H04N 5/91

(52) U.S. Cl. 386/83

(57) ABSTRACT

A method to control recording of a digital program includes receiving a recording instruction to record the digital program. The method further includes determining a time at which the recording instruction is received. A predefined recording profile for the digital program is retrieved, the recording profile comprising an allowed time range during which the digital program can be recorded. The program is allowed to be recorded if the determined time at which the recording instruction is received falls within the allowed time range as provided by the predefined recording profile for the digital program.

### FIELD OF THE DISCLOSURE

The present disclosure relates to digital video recorders (DVRs) (also known as personal video recorders (PVRs), and in an example embodiment to a method and system to control recording of a digital program by a DVR.

### BACKGROUND

A DVR may be used to record digital television content transmitted to a set-top box, with name-based recurring recordings being a staple of the functionality of DVR's. This feature allows a user to request that all episodes of a certain show be recorded, no matter what channel or time of day they are broadcast. Significantly, however, the DVR automatically changes to the relevant channel when it is to record a requested show on that channel. This creates a unique issue for some users, in that current broadcast and/or pay television (TV) lineups may feature inappropriate (e.g., adult-oriented) programming throughout the day. Thus, name-based recurring recordings in such situations are potentially problematic in that there is a risk that the channel will be changed to inappropriate programming while live TV is being watched. This creates an especial issue for parents who have set up name-based recordings for shows that are inappropriate for children, but who do not want the channel automatically changed to this content while children are watching live TV.

Currently, this is a difficult problem for the user to police. To carry out name-based recurring recordings, the DVR reviews electronic program guide (EPG) data, which is automatically updated on a regular basis. If the DVR finds one or more shows matching the names the user has specified, it sets recording events. Because television providers often reschedule programs, the show may move from what the user deemed an acceptable time for recording (for example, after children have gone to bed) to a time when the user would rather not have the show recorded. Because the DVR automatically adjusts its recording events based on updated EPG data, the user will not know this adjustment has been made unless they specifically look at the list of upcoming recordings on an almost daily basis.

This is also an issue with single-instance recordings. Because one of the main benefits of DVR's is that they allow users to record shows to watch at another time, users often do not consider the time of broadcast when scheduling single-instance recordings. For example, the user could search for a desired program, find it, and schedule a recording, all without paying attention to when the show will be broadcast. This may result in the DVR changing the channel when the user's children are watching TV, possibly to a show containing objectionable content.

### BRIEF DESCRIPTION OF THE DRAWINGS

Embodiments are illustrated by way of example and limitation in the figures of the accompanying drawings, in which

FIG. 1 is a block diagram representative of an entertainment system according to an example embodiment

FIG. 2 is a flow chart to illustrate general operating logic, according to an example embodiment, that can be used to control recording of a digital program

FIG. 3 is a flow chart to illustrate general operating logic that can be used to define a recording profile for a digital program, according to an example embodiment

FIGS. 4(a) to 4(d) are screen shots corresponding to the flow chart shown in FIG. 3

FIG. 5 is a schematic overview of a Home DVR (HDVR) setup, according to an example embodiment;

FIG. 6 is a schematic overview of a Network DVR (NDVR) setup, according to an example embodiment; and

FIG. 7 shows a diagrammatic representation of machine in the example form of a set-top box within which a set of instructions, for causing the machine to perform any one or more of the methodologies discussed herein, may be executed.

### DETAILED DESCRIPTION OF THE DRAWINGS

A method to control recording of a digital program is provided. The method includes receiving a recording instruction to record the digital program. The method further includes determining a time at which the recording instruction is received. A predefined recording profile for the digital program is retrieved, the recording profile comprising an allowed time range during which the digital program can be recorded. The program is allowed to be recorded if the determined time at which the recording instruction is received falls within the allowed time range as provided by the predefined recording profile for the digital program.

A system to control recording of a digital program is also provided. The system comprises an interface to receive a recording instruction to record the digital program. A timer is used to determine a time at which the recording instruction is received by the interface. A memory stores a recording profile comprising an allowed time range for recording of the digital program, with a recording module being used to retrieve the predefined recording profile from the memory and to allow the program to be recorded if the determined time at which the recording instruction is received falls within the allowed time range as provided by the predefined recording profile for the digital program.

In another embodiment, a method to define a recording profile for a digital program is provided. The method comprises identifying the digital program, assigning an allowed time range during which the identified digital program can permissibly be recorded, and saving the identified digital program and its assigned allowed time range so as to define a recording profile.

In yet a further embodiment, a system to define a recording profile for a digital program is provided. The system comprises an interface to identify the digital program and to assign an allowed time range during which the identified digital program can be recorded. A memory is used to store the identified digital program and its assigned allowed time range so as to define a recording profile.

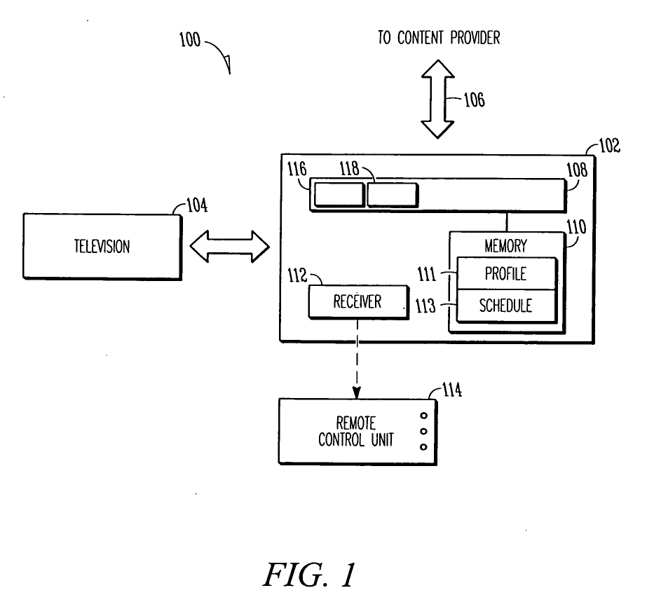

Referring to FIG. 1, a system is shown and is generally designated 100. As shown, the system 100 includes a digital video recorder (DVR) 102 that is coupled to a display device, such as a television 104. Additionally, the DVR 102 may form part of a set-top box that is coupled to a content provider 106. For the purposes of this disclosure, the term “DVR” shall be taken to include any device that has the capability to record content (e.g., video content, such as broadcast or pay-TV content) to a digital storage medium. The term DVR may be used to describe a piece of equipment such as a Personal Video Recorder (PVR) or a CCTV DVR. It may also be used to reference a function in a piece of equipment (e.g., a television set or a digital video camera) that has a DVR function built into it.

As shown in FIG. 1, the DVR 102 includes a processor 108 and a memory device 110 that is coupled to the processor 108. The memory device 110 stores a recording profile 111 specifying an allowed time range for recording a digital program received by the DVR 102. A receiver 112 is coupled to the processor 108, with a remote control unit 114 being usable to communicate with the DVR 102 via the receiver 112. In a particular embodiment, the receiver can be an infrared (IR) receiver or a radio frequency (RF) receiver.

A user can input one or more commands to the DVR 102 using the remote control unit 114. These commands may include the setting up of a recurring recording schedule in which the user can request that all (or only certain) episodes of a certain show be recorded, no matter what channel or time of day they are broadcast, with the recurring recording schedule being stored in the memory device 110. The remote control unit 114 may also be used to send a recording instruction to the DVR 102 as a single-instance recording event.

The processor 108 defines an interface to receive a recording instruction to record the digital program, the recording instruction emanating from the recurring recording schedule 113 stored in the memory device 110 or from the remote control unit 114. In an example embodiment, and with particular reference to the use of a recurring recording schedule 113, the DVR 102 makes use of EPG data to provide the recording instruction to the processor 108.

The DVR 102 also includes a timer 116 to determine a time at which the recording instruction is received by the processor 108.

The DVR 102 further includes a recording module 118 to retrieve the predefined recording profile 111 from the memory device 110 and to allow the program to be recorded if the determined time at which the recording instruction is received falls within the allowed time range as provided by the predefined recording profile for the digital program.

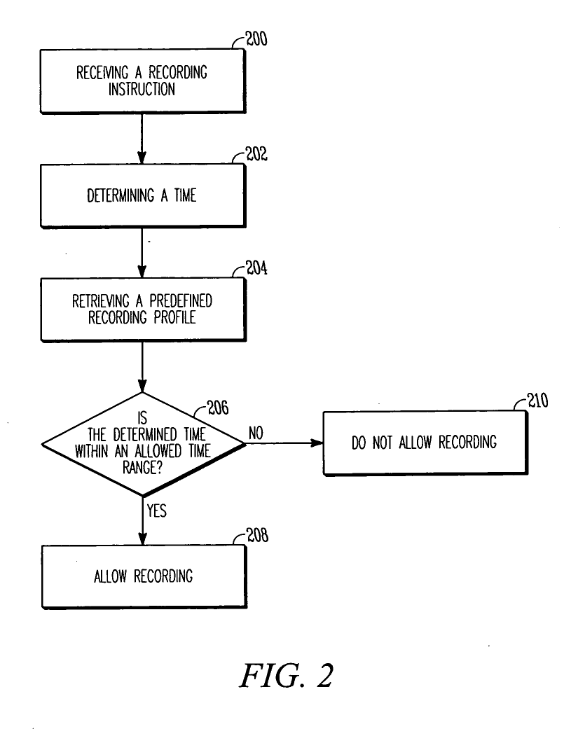

Turning now to FIG. 2, the processor 108 (FIG. 1) first receives a recording instruction to record a digital program, as indicated by block 200. The timer 116 (FIG. 1) is then used to determine a time at which the recording instruction is received, as indicated by block 202. A predefined recording profile 111 for the digital program is retrieved, with the recording profile comprising an allowed time range during which the digital program can be recorded, as indicated by block 204. The determined time is then compared to the allowed time range, as indicated by decision block 206, and if the determined time at which the recording instruction is received falls within the allowed time range as provided by the predefined recording profile 111 for the digital program, the program is allowed to be recorded, as indicated by block 208. If, however, the determined time at which the recording instruction is received does not fall within the allowed time range, the program is not allowed to be recorded, as indicated by block 210.

In an example embodiment, the predefined recording profile 111 for the digital program may further include at least one day of the week on which the digital program can be recorded. Thus, the digital program will only be allowed to be recorded if both the determined time of receiving the recording instruction falls within the allowed time range and the day on which the recording instruction is received corresponds to one of the allowed days.

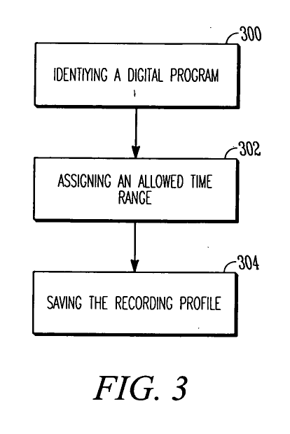

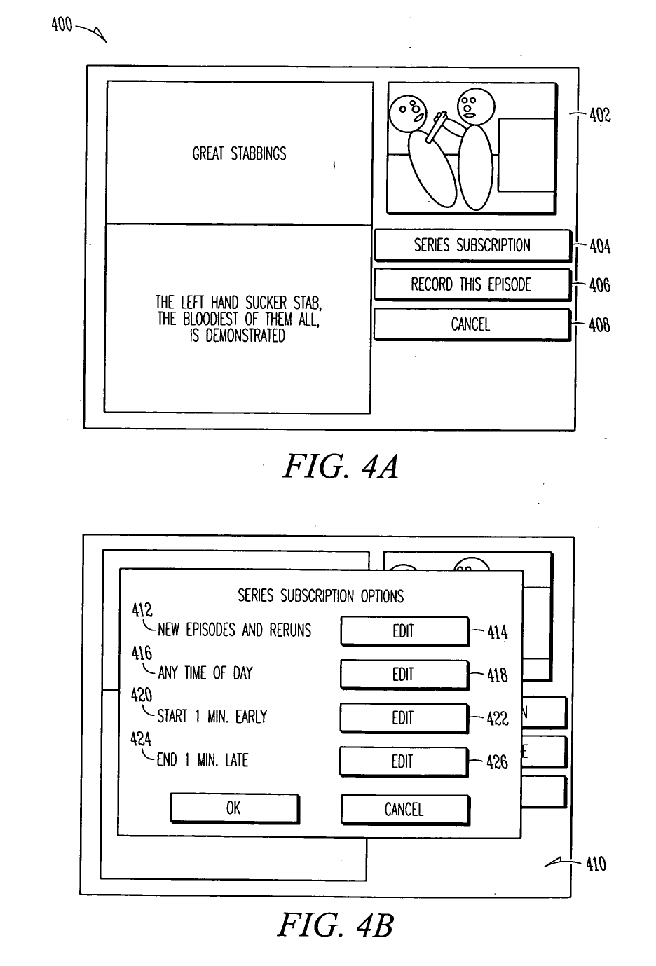

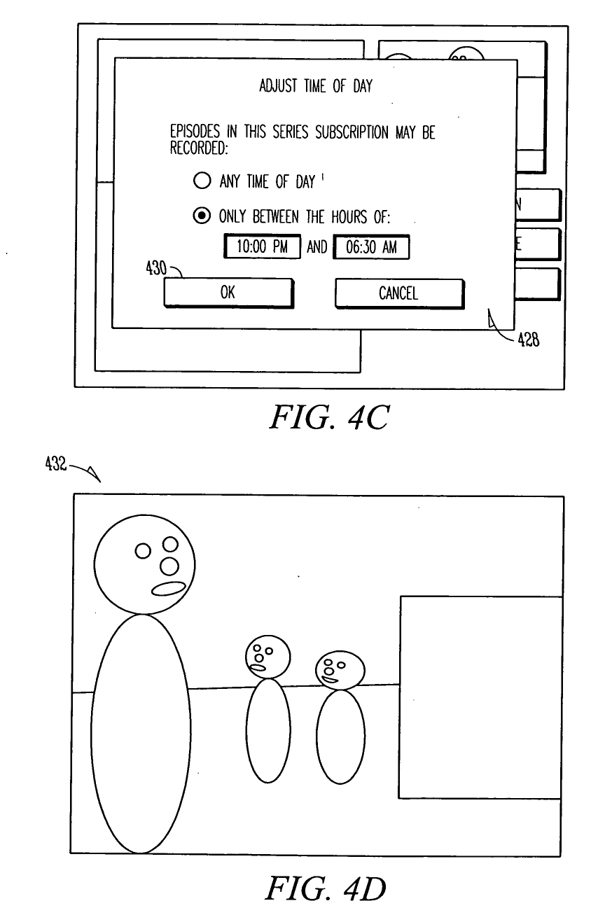

Turning now to FIGS. 3 and 4(a) to 4(d), a method to define a recording profile 111 for a digital program will now be described. A typical recording screen 400 is shown in FIG. 4(a), comprising a digital program of possibly objectionable (or inappropriate) content 402, a Series Subscription button 404 to allow a user to record all (or a selected (e.g., new or rerun)) episodes of a particular digital program, a Record This Episode button 406 to allow the user to record a particular episode, and a Cancel button 40.

In an example embodiment, the user can set up a recurring recording schedule 113 in which all episodes of a particular program series are to be recorded. To define the recording profile 111 for digital programs, the user first clicks on the Series Subscription button 404, which will yield a Series Subscription Options screen shot 410 as shown in FIG. 4(b). The screen shot 410 comprises a New Episodes and Reruns option 412 and associated Edit button 414, an Any Time of Day option 416 and associated Edit button 418, a Start 1 Min. Early option 420 and associated Edit button 422, and an End 1 Min. Late option 424 and associated Edit button 426.

The method to define a recording profile first comprises identifying the relevant digital program. This may be done by clicking on the Edit button 414 associated with the New Episodes and Reruns option 412. This is indicated by block 300 in FIG. 3. The user can then select the relevant digital program, in a well known manner. Thereafter, the user assigns an allowed time range during which the identified digital program can permissibly be recorded, as shown by block 302 in FIG. 3. This may be achieved by clicking on the Edit button 422 associated with the Any Time of Day option 416. This calls up an Adjust Time of Day screen 428, as shown in FIG. 4(c). This screen allows an allowed time range, in this case between 10:00 PM and 06:30 AM, to be defined, during which episodes in the selected series subscription may be recorded. The recording profile 111 is then saved onto the memory device 110 (FIG. 1) by selecting the OK button 430.

Thus, in this case, the selected digital program will only be recorded if the time at which it is being broadcast falls between 10:00 PM and 06:30 AM. If it does not fall within this time range, instead of the DVR switching over to the relevant channel, which will result in the display of the possibly objectionable content 402, the DVR will remain on the current channel, and continue to show current content, as indicated by screen 432. In other words, if a series subscription with a time constraint appears outside the user-defined allowable hours, it will not be recorded.

Although not shown, in a further example embodiment, an allowed time range (e.g., a generic allowed time range) may be assigned to a plurality of digital programs. In a further example embodiment, in addition to an assigned time range being assigned to a particular digital program, a day or days of the week on which the digital program can be recorded can also be assigned to any one particular digital program or to a plurality of digital programs.

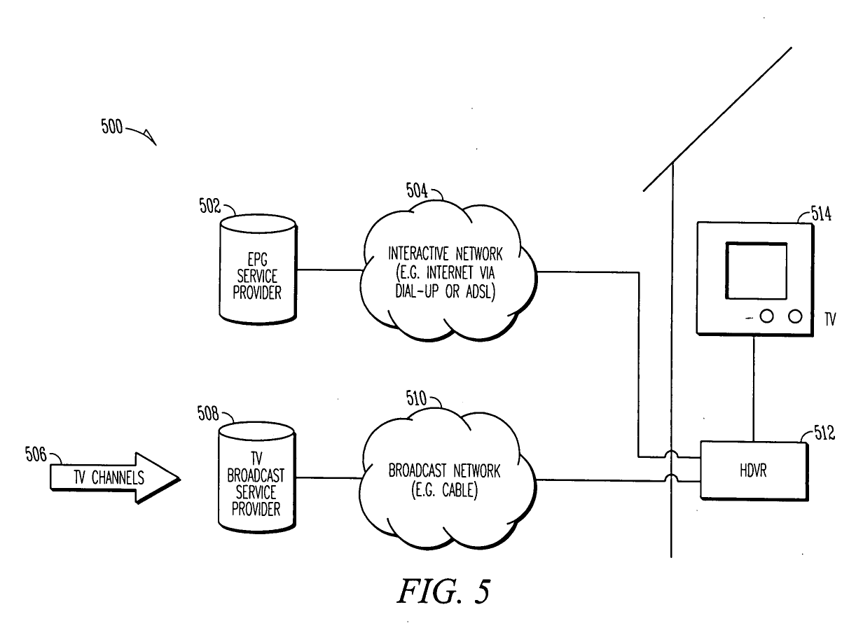

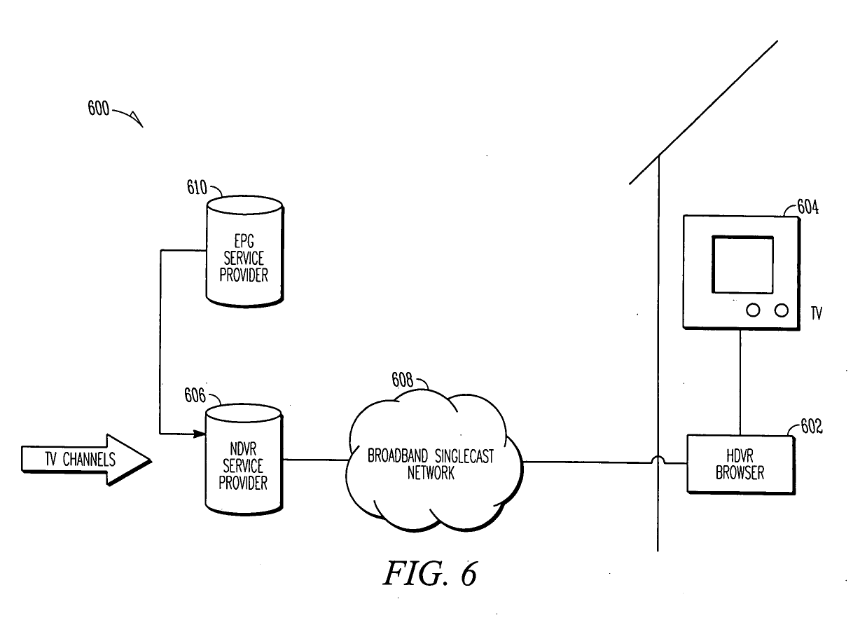

The method and system to control recording of a digital program may be setup as either a Home DVR (HDVR) or a Network DVR (NDVR). The HDVR arrangement, which may correspond to the system 100 and DVR 102 shown in FIG. 1, will now be described in more detail with reference to FIG. 5, and the NDVR will thereafter be described with reference to FIG. 6.

Referring first to FIG. 5, the content provider 106 (FIG. 1) in a HDVR system 500 provides both EPG data from an EPG service provider 502 via an interactive network 504, as well as the actual television content 506 from a TV broadcast service provider 508 via a broadcast network 510. The EPG data and television content then get received and processed by a HDVR 512 and displayed on a television 514, as described above. The HDVR 512 comprises components similar to the components already described above with reference to FIG. 1, and will thus not be repeated here.

Turning now to FIG. 6, the method and system to control recording of a digital program can also be implemented as a network service in an NDVR system 600. The system 600 includes a residential NDVR browser 602 (and associated television 604) that communicates with an NDVR service provider 606 at a remote location via, in an example embodiment, a broadband singlecast network 608. In this case, the predefined profile may be stored at the NDVR service provider 606, with an EPG service provider 610 feeding the EPG data directly to the NDVR service provider 606. However, the actual operation of the method and system to control recording of a digital program is the same, save that the predefined profile may be stored at a remote location and not in the memory device 110 (FIG. 1) within the user's own DVR. In this case, should the recording of a digital program be allowed in terms of the predefined recording profile, the recorded digital program can be stored either by the NDVR service provider 606 or by the NDVR browser 602 itself.

An advantage of the NDVR system 600 is that it may allow the recording profile 111 to be defined by a remote third party, such as the NDVR service provider 606 itself, as opposed to the recording profile being defined by the user him- or herself, as described above.

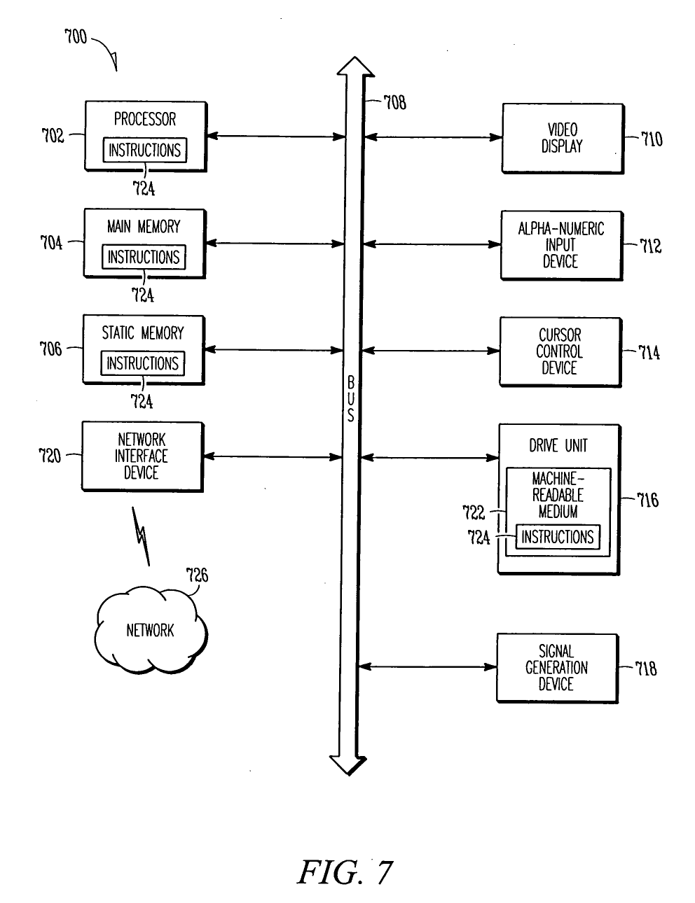

FIG. 7 shows a diagrammatic representation of machine in the example form of a set-top box 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a digital video recorder (DVR), a personal video recorder (PVR), a Personal Digital Assistant (PDA), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example set-top box 700 includes a processor 702 (e.g., a central processing unit (CPU), a graphics processing unit (GPU) or both), a main memory 704 and a static memory 706, which communicate with each other via a bus 708. The set-top box 700 may further include a video display unit 710 (e.g., a liquid crystal display (LCD) or a cathode ray tube (CRT)). The set-top box 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the set-top box 700, the main memory 704 and the processor 702 also constituting machine-readable media.

The software 724 may further be transmitted or received over a network 726 via the network interface device 720 utilizing any one of a number of well-known transfer protocols (e.g., HTTP). While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

What is claimed is:

1. A method to control recording of a digital program, the method comprising:
receiving a recording instruction to record the digital program;
determining a time at which the recording instruction is received;
retrieving a predefined recording profile for the digital program, the recording profile comprising an allowed time range during which the digital program can be recorded; and
allowing the program to be recorded if the determined time at which the recording instruction is received falls within the allowed time range as provided by the predefined recording profile for the digital program.

2. The method of claim 1, wherein the recording instruction is part of a recurring recording schedule.

3. The method of claim 1, wherein the recording instruction is a single-instance recording event.

4. The method of claim 1, wherein the predefined recording profile includes a generic allowed time range that applies to a plurality of digital programs.

5. The method of claim 1, wherein the predefined recording profile for the digital program further includes at least one day of the week on which the digital program can be recorded.

6. The method of claim 1, wherein the predefined recording profile is a user-defined recording profile.

7. The method of claim 1, wherein the predefined recording profile is defined by a remote third party.

8. A system to control recording of a digital program, the system comprising:
an interface to receive a recording instruction to record the digital program;
a timer to determine a time at which the recording instruction is received by the interface;
a memory to store a recording profile comprising an allowed time range for recording of the digital program;
a recording module to retrieve the predefined recording profile from the memory and to allow the program to be recorded if the determined time at which the recording instruction is received falls within the allowed time range as provided by the predefined recording profile for the digital program.

9. The system of claim 8, wherein the recording instruction is part of a recurring recording schedule.

10. The system of claim 8, wherein the recording instruction is a single-instance recording event.

11. The system of claim 8, wherein the predefined recording profile comprises a generic allowed time range that applies to a plurality of digital programs.

12. The system of to claim 8, wherein the predefined recording profile for the digital program further comprises at least one day of the week on which the digital program can be recorded.

13. The system of claim 8, wherein the predefined recording profile is a user-defined recording profile.

14. The system of claim 8, wherein the predefined recording profile is defined by a remote third party.

15. A machine-readable medium embodying instructions which, when executed by a machine, cause the machine to perform the method of claim 1.

16. A method to define a recording profile for a digital program, comprising:
identifying the digital program;
assigning an allowed time range during which the identified digital program can permissibly be recorded; and
saving the identified digital program and its assigned allowed time range so as to define a recording profile.

17. The method of claim 16, wherein the recording profile is part of a recurring recording schedule.

18. The method of claim 16, which comprises assigning the allowed time range to a plurality of digital programs.

19. The method of claim 16, which comprises assigning at least one day of the week on which the digital program can be recorded.

20. The method of to claim 16, wherein the defined recording profile is a user-defined recording profile.

21. The method of claim 16, wherein the defined recording profile is defined by a remote third party.

22. A system to define a recording profile for a digital program, the system comprising:
an interface to identify the digital program and to assign an allowed time range during which the identified digital program can be recorded; and
a memory to store the identified digital program and its assigned allowed time range so as to define a recording profile.

23. The system of claim 22, wherein the recording profile is part of a recurring recording schedule.

24. The system of claim 22, which comprises assigning the allowed time range to a plurality of digital programs.

25. The system of claim 22, which comprises assigning at least one day of the week on which the digital program can be recorded.

26. The system of claim 22, wherein the defined recording profile is a user-defined recording profile.

27. The system of claim 22, wherein the defined recording profile is defined by a remote third party.

28. A machine-readable medium embodying instructions which, when executed by a machine, cause the machine to perform the method of claim 16.

29. A system for controlling a recording of a digital program, comprising:
means for receiving a recording instruction to record the digital program;
means for determining a time at which the recording instruction is received;
means for retrieving a predefined recording profile for the digital program, the recording profile comprising an allowed time range during which the digital program can be recorded; and
means for allowing the program to be recorded if the determined time at which the recording instruction is received falls within the allowed time range as provided by the predefined recording profile for the digital program.
